(19) United States
(12) Patent Application Publication
(10) Pub. No.: US 2024/0284957 A1
(43) Pub. Date: Aug. 29, 2024

(54) METHOD FOR MANUFACTURING MEAT SUBSTITUTE FOR CRUSTACEAN MEAT

(71) Applicant: BIPPECO, Seoul (KR)

(72) Inventors: Hyun Jin PARK, Seoul (KR); Sun Min KIM, Seoul (KR)

(73) Assignee: BIPPECO, Seoul (KR)

(21) Appl. No.: 18/573,947

(22) PCT Filed: Nov. 18, 2021
(86) PCT No.: PCT/KR2021/016945

§ 371 Date: Dec. 22, 2023

(30) Foreign Application Priority Data
Jun. 24, 2021 (KR) 10-2021-0082095

(51) Int. Cl. A23P 30/25; A23L 17/00; A23L 29/212; A23P 20/15; A23P 20/25; B33Y 10/00; B33Y 30/00; B33Y 70/00; B33Y 80/00

(52) U.S. Cl. CPC A23P 30/25; A23L 17/70; A23L 29/212; A23P 20/15; B33Y 10/00; B33Y 30/00; B33Y 70/00; B33Y 80/00; A23P 2020/253

(57) ABSTRACT

The present invention relates to a method for manufacturing a meat substitute for crustacean meat. A method for manufacturing a meat substitute for crustacean meat, according to one embodiment of the present invention, comprises (S100) a step for dissolving starch in water to prepare a starch gel, and (S200) a step for adding the starch gel into an external nozzle of a 3D printer, which has a double nozzle in which an internal nozzle is inserted and arranged inside the external nozzle, adding a fish meat composition into the internal nozzle, then discharging the starch gel and fish meat composition at the same time and 3D-printing into a predetermined form.

### TECHNICAL FIELD

The present invention relates to a method for producing a meat substitute for crustacean soft tissue, and more specifically to a method for producing a meat substitute for crustacean soft tissue that uses a fish meat protein composition to allow the meat substitute to have similar physical properties to the inherent texture of crustacean meat.

### BACKGROUND ART

Generally, imitation crab meat is a processed food whose color, shape, and texture are made close to those of actual crab meat. Pollack is mainly used as a material for imitation crab meat. Imitation crab meat is shaped by adding a small amount of salt to pollack to make a surimi paste, spinning filaments from the surimi paste, allowing the filaments to aggregate, and compressing and cutting the aggregate. Imitation crab meat is used as a supplementary material for a variety of dishes such as kimbap, salad, and skewers. Imitation crab meat is a fish meat product that is widely eaten as a snack for children or a side dish for drinks. Imitation lobster meat whose shape is similar to that of imitation crab meat have also been introduced into the market.

However, conventional methods for the texture of tender crustacean meat-like foods such as imitation crab meat or imitation lobster meat do not provide a distinct texture or tearable structure of crustacean soft tissue, failing to achieve satisfactory sensory quality levels in terms of taste and texture over actual crustacean meat.

Thus, there is an urgent need to develop a method for producing a meat substitute for crustacean soft tissue in which the inherent tissue of crustaceans is realized.

### DETAILED DESCRIPTION OF THE INVENTION

### Problems to be Solved by the Invention

The present invention has been made in an effort to solve the problems of the prior art, and an aspect of the present invention is to provide a method for producing a meat substitute for crustacean soft tissue that uses a 3D printer equipped with a coaxial nozzle to realize a distinct texture and tearable structure of crustacean soft tissue.

A method for producing a meat substitute for crustacean soft tissue according to an embodiment of the present invention includes (a) dissolving starch in water to form a starch gel and (b) feeding the starch gel into an outer nozzle of a dual-nozzle 3D printer in which an inner nozzle is insertedly arranged inside the outer nozzle, feeding a fish meat composition into the inner nozzle, and subjecting the starch gel and the fish meat composition to 3D printing into a predetermined shape while simultaneously ejecting the starch gel and the fish meat composition.

According to an exemplary embodiment of the present invention, the concentration of the starch in the starch gel may be 10 to 14%.

According to an exemplary embodiment of the present invention, the starch may be potato starch.

According to an exemplary embodiment of the present invention, the fish meat composition may include pollock surimi.

According to an exemplary embodiment of the present invention, the outer nozzle may have a diameter of 1.4 to 1.6 nm and the inner nozzle may have a diameter of 0.8 to 1.2 nm.

According to an exemplary embodiment of the present invention, in step (b), the starch gel may be ejected at a speed of 0.005 to 0.015 ml/min.

According to an exemplary embodiment of the present invention, in step (a), the starch dissolved in the water may be gelatinized by stirring at 60 to 80° C.

According to an exemplary embodiment of the present invention, in step (b), the 3D printed material ejected through the dual nozzle may include a core composed of the fish meat composition in the form of a yarn and a shell composed of the starch gel coated on the surface of the core.

According to an exemplary embodiment of the present invention, in step (b), the 3D printed material may have at least one pattern selected from the group consisting of linear, grid, and circular patterns.

The features and advantages of the present invention will become apparent from the following description with reference to the accompanying drawings.

Prior to the detailed description of the invention, it should be understood that the terms and words used in the specification and the claims are not to be construed as having common and dictionary meanings but are construed as having meanings and concepts corresponding to the technical spirit of the present invention in view of the principle that the inventor can define properly the concept of the terms and words in order to describe his/her invention with the best method.

### Effects of the Invention

The method of the present invention enables the production of a meat substitute whose tissue is similar to that of actual crustacean meat. Therefore, the method of the present invention can extend the range and consumption pattern of available products.

In addition, the method of the present invention enables the manufacture of food products with various infill patterns such as grid and concentric patterns, achieving improved textures of the products compared to existing food products and allowing the products to have textures that satisfy consumers' demands.

### BRIEF DESCRIPTION OF THE DRAWINGS

FIG. 1 is a flowchart illustrating a method for producing a meat substitute for crustacean soft tissue according to an embodiment of the present invention.

FIG. 2 is a view for explaining the 3D printing step of FIG. 1.

FIGS. 3a to 3b show the dynamic viscoelastic properties of materials for meat substitutes (pollack surimi and potato starch gels) for crustacean soft tissue prepared in Experimental Example 1. Specifically, FIGS. 3a and 3b show changes in the storage modulus (G′) and loss modulus (G″) of the materials, respectively.

FIG. 4 shows images revealing the 3D printer suitability of potato starch gels having different concentrations for meat substitutes for crustacean soft tissue, which was tested in Experimental Example 2.

FIG. 5 shows images revealing a 3D printing process used in Experimental Example 2 and meat substitutes with various infill patterns for crustacean soft tissue produced in Experimental Example 2.

FIGS. 6a to 6b show the results of a penetration test on meat substitutes with various infill patterns for crustacean soft tissue in Experimental Example 3. Specifically, FIGS. 6a to 6c show the breaking forces, penetration distances, and gel strengths of the meat substitutes.

FIG. 7 is a table showing the results of texture profile analysis (TPA) for meat substitutes with different infill patterns for crustacean soft tissue in Experimental Example 3.

FIG. 8 shows the results of cutting tests for meat substitutes with various infill patterns for crustacean soft tissue in Experimental Example 3.

### BEST MODE FOR CARRYING OUT THE INVENTION

The objects, specific advantages, and novel features of the present invention will become apparent from the following detailed description and preferred embodiments in conjunction with the accompanying drawings. It should be noted that in the drawings, the same components are denoted by the same reference numerals even though they are depicted in different drawings. In the description of the present invention, detailed explanations of related art are omitted when it is deemed that they may unnecessarily obscure the essence of the present invention.

Preferred embodiments of the present invention will now be described in detail with reference to the accompanying drawings.

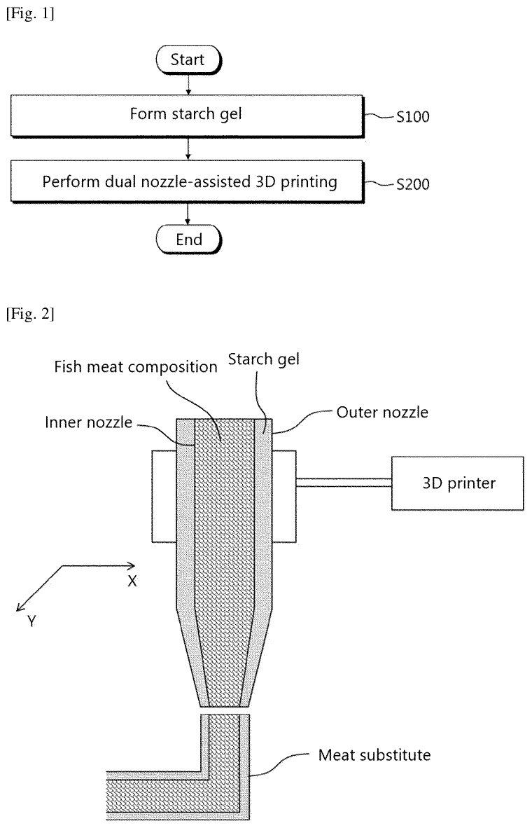

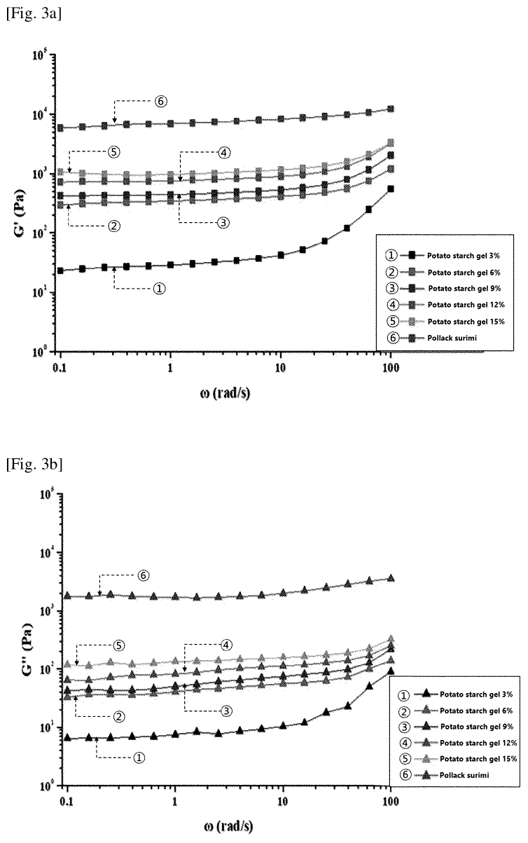

As shown in FIGS. 1 and 2, a method for producing a meat substitute for crustacean soft tissue according to an embodiment of the present invention includes (S100) dissolving starch in water to form a starch gel and (S200) feeding the starch gel into an outer nozzle of a dual-nozzle 3D printer in which an inner nozzle is insertedly arranged inside the outer nozzle, feeding a fish meat composition into the inner nozzle, and subjecting the starch gel and the fish meat composition to 3D printing into a predetermined shape while simultaneously ejecting the starch gel and the fish meat composition.

The present invention is directed to a method for producing a meat substitute for crustacean soft tissue that uses a fish meat protein composition to allow the meat substitute to have similar physical properties to the inherent texture of crustacean meat. A meat substitute for crustacean soft tissue is a processed food whose color, shape, and texture are made close to those of actual crustacean (for example, crab or lobster) meat. The meat substitute may be, for example, imitation crab meat or imitation lobster meat. The crustacean processed food is manufactured by extruding a fish meat paste. However, extrusion is not suitable to provide a distinct texture or tearable structure of crustacean soft tissue, failing to achieve satisfactory sensory quality levels in terms of taste and texture over actual crustacean meat. Thus, the present invention has been devised as a solution to this problem.

As described above, the method includes (S100) forming a starch gel and (S200) 3D printing.

In S100, starch is dissolved in water to form a starch gel. Starch is a food material that can be used as a tissue binder. The ability to bind to tissue is required to create a texture and a fibrous structure similar to those of real food. For this purpose, starch is used in the present invention.

Since the starch gel is used as a printing material in the subsequent 3D printing, its suitable printability is required. To this end, it is preferable that the concentration of the starch in the starch gel is between 10 and 14%. If the starch concentration is lower than 10%, the starch gel may collapse simultaneously with 3D printing or may be impossible to stack. Meanwhile, if the starch concentration is higher than 14%, the starch gel may be difficult to extrude through a nozzle. That is, the starch concentration is determined taking into consideration the shape retention and the ease of extrusion of the starch gel during 3D printing.

The starch may be potato starch. Potato starch can be used as a storage stabilizer, gelling agent, binding agent or thickening agent in the food field. Potato starch forms a sticky and transparent gelatinized liquid due to its high viscosity when gelatinized. The viscosity of potato starch tends to gradually decrease with time.

In S100, starch is dissolved in water and gelatinized by stirring at a temperature of 60 to 80° C. to form a starch gel.

In S200, a dual-nozzle 3D printer is used to print a meat substitute for crustacean soft tissue. The dual nozzle is a coaxial nozzle composed of an outer nozzle and an inner nozzle insertedly arranged inside the outer nozzle. The dual nozzle ejects materials fed thereinto while moving right, left, up, and down. Any known 3D printer that can print food materials may be used without particular limitation, and thus a detailed description thereof is omitted.

3D printing is a concept that contrasts with a cutting process for forming a material into a desired shape. The official term of 3D printing is additive manufacturing (AM). 3D printing is performed based on a modeling process for product design using a three-dimensional digital drawing and a printing process for making a three-dimensional object by layer-by-layer stacking. If necessary, 3D printing may further include one or more post-processing processes such as drying, cooling, gelation, and heating. However, 3D printing has some limitations despite its unlimited availability. The desired shape, color, flavor, texture, and nutritional factors of existing food products have been implemented by skilled technicians. In contrast, 3D printing integrated with suitable technology can be applied to processes for food manufacturing on a small or industrial scale but has limitations in realizing the texture of food. That is, a printed product through conventional 3D printing and subsequent processing is in the form of a texture-free chunk. In contrast, the method of the present invention uses a coaxial nozzle to realize a distinct and tearable texture, like crustacean soft tissue.

A fish meat composition is fed into the inner nozzle and the starch gel is fed into the outer nozzle. The fish meat composition may include fish meat used in existing imitation crab meat or imitation lobster meat. The fish meat may be, for example, ground pollack surimi.

When dual nozzle-assisted 3D printing is performed, the fish meat composition and the starch gel are ejected simultaneously. The ejected 3D printing materials may be printed into a predetermined shape by controlling the movement of the dual nozzle. The 3D printing materials are ejected in the form of yarns through the nozzle. Specifically, the 3D printing materials are ejected in the form of core-shell structured yarns in which the fish meat composition forms a yarn-shaped core and the starch gel is coated on the surface of the core to form a shell. The 3D printing materials may be 3D printed into at least one pattern selected from the group consisting of linear, grid, and circular patterns. That is, the 3D printing allows the meat substitute to have various infill patterns.

The outer nozzle may have a diameter of 1.4 to 1.6 nm and the inner nozzle may have a diameter of 0.8 to 1.2 nm. The starch gel may be ejected at a speed of 0.005 to 0.015 ml/min.

Overall, the method of the present invention enables the production of a meat substitute whose tissue is similar to that of actual crustacean meat. Therefore, the method of the present invention can extend the range and consumption pattern of available products. In addition, the method of the present invention enables the manufacture of food products with various infill patterns such as grid and concentric patterns, achieving improved textures of the products compared to existing food products and allowing the products to have textures that satisfy consumers' demands.

### MODE FOR CARRYING OUT THE INVENTION

The present invention will be described in more detail with reference to the following experimental examples. In these experimental examples, meat substitutes for crustacean soft tissue were produced. In addition, the rheological properties and 3D printing suitability of materials for the meat substitutes were evaluated and the effects of the meat substitutes on food properties and final product quality were analyzed to verify whether the meat substitutes could realize the texture of actual crustacean meat.

### Experimental Example 1: Preparation and Evaluation of Dynamic Viscoelastic Properties of Meat Substitutes for Crustacean Soft Tissue

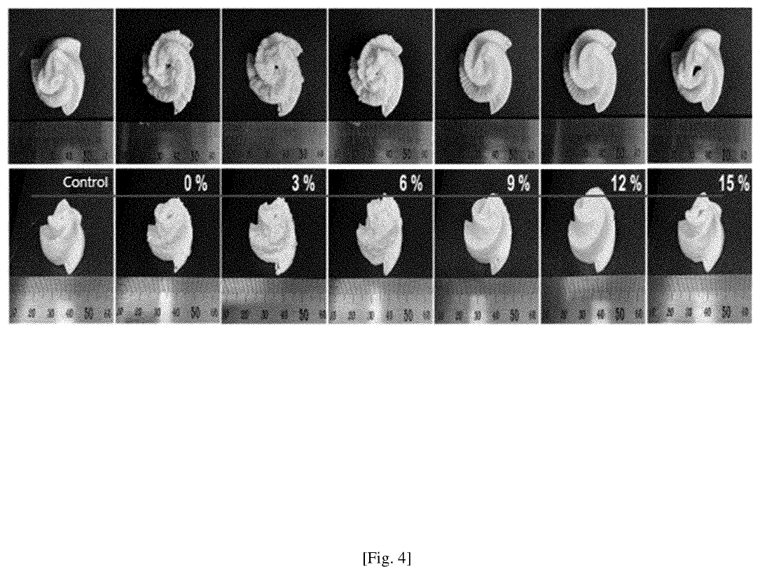

Frozen pollack surimi was thawed and ground to prepare a fish meat composition. Potato starch was dissolved at different concentrations (0, 3, 6, 9, and 12%) in water and gelatinized with continuous stirring at 70° C. for 5 min to form potato starch gels. The dynamic viscoelasticities of the pollack surimi and the potato starch gels were measured. The results are shown in FIGS. 3a and 3b. FIGS. 3a to 3b show the dynamic viscoelastic properties of the materials (the pollack surimi and the potato starch gels) for meat substitutes for crustacean soft tissue. Specifically, FIGS. 3a and 3b show changes in the storage modulus (G′) and loss modulus (G″) of the materials, respectively. The dynamic viscoelasticities of the pollock surimi and the potato starch gels were measured using a controlled stress rheometer (Paar Physica MCR 302, Anton Paar, Graz, Austria), whose gap was set to 1 mm, with a sandblasted parallel plate (PP25/S) having a diameter of 25 mm. A strain sweep test was conducted at 10 rad/s to obtain the linear viscoelastic (LVE) region between shear stress and shear strain for dynamic viscoelastic analysis. A strain of 0.1% within the linear viscoelastic region was selected as an experimental condition. All samples were analyzed at a frequency of 0.1 to 100 rad/s at 25° C. The storage (G′) and loss moduli (G″) were measured with an analysis program (RheoCompass™, Anton Paar, Graz, Austria) embedded in the rheometer.

Referring to FIGS. 3a and 3b, the G′ and G″ values of the pollack surimi were the highest and both G′ and G″ values tended to increase with increasing concentration of the potato starch. If the values are too low, the shape of a 3D printed product tends to collapse, resulting in unsuccessful stacking of the starch gel. Meanwhile, if the values are too high, the materials are difficult to eject through a syringe pump. In the present invention, the potato starch gel is coated on the outside of the pollock surimi through a thin nozzle and it is thus very important to understand the characteristics of the coating.

### Experimental Example 2: Evaluation of 3D Printing Suitability of the Materials for Meat Substitutes for Crustacean Soft Tissue

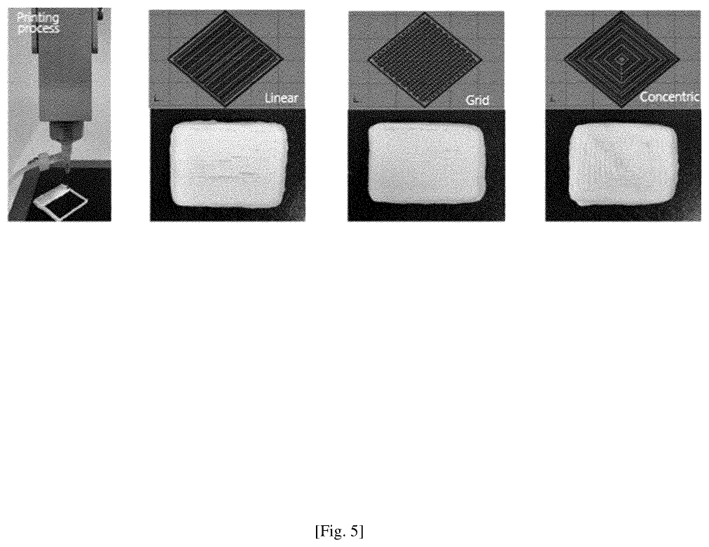

Each of the potato starch gels prepared in Experimental Example 1 was fed into an outer nozzle with a diameter of 1.6 mm and the ground pollack surimi prepared in Experimental Example 1 was fed into an inner nozzle with a diameter of 1 mm. Thereafter, the materials were subjected to 3D printing while being ejected. As a result, a material was printed in the form of yarns in which the potato starch gel was coated on the pollack surimi as a core. The potato starch gel was ejected at a speed of 0.01 ml/min through a syringe pump (KDS-410, KD Scientific Inc., USA). The printed material was molded into a tornado shape (height: 200 mm; diameter: 40 mm). After a rest period of 20 min, 3D printing suitability was evaluated. FIG. 4 shows images revealing the 3D printer suitability of the potato starch gels having different concentrations.

Referring to FIG. 4, a control and samples using the 0-6% potato starch gels collapsed simultaneously with printing or stacking of the potato starch gels did not occur. The sample using the 9% potato starch gel did not collapse during the printing process, but the supporting strength of the lower layer was weakened and the height of the center was lowered after the rest period. For the sample using the 12% potato starch gel, smooth ejection, high shape retention, and high quality were observed. For the sample using the 15% potato starch gel, the thin coaxial nozzle was clogged due to the high dynamic viscoelasticity (see FIGS. 3a and 3b). The nozzle clogging made it difficult to exclude the starch gel, and as a result, empty parts were observed. Thus, the potato starch gel was evaluated to have poor suitability for 3D printing. Consequently, it can be concluded that the use of the 12% potato starch gel is most suitable for 3D printing.

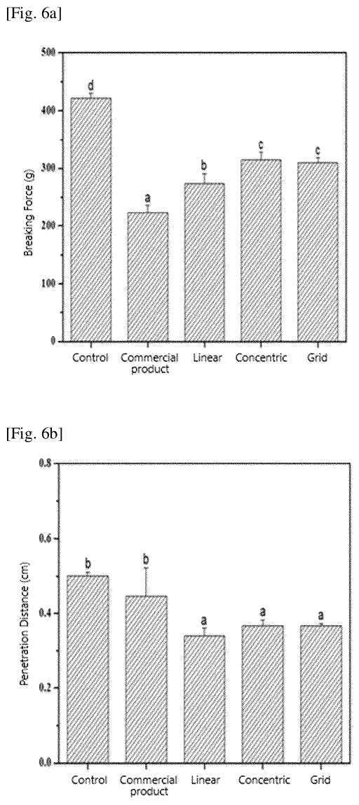

FIG. 5 shows images revealing the 3D printing process and the meat substitutes with various infill patterns. As shown in FIG. 5, the meat substitutes produced formed by 3D printing had linear, grid, and concentric infill patterns.

### Experimental Example 3: Evaluation of Physical Properties of Foods and Quality of Final Products

3D printed cuboid-shaped samples (width/length 30 mm, height 10 mm) were used for texture analysis. The texture analysis was done after a post-processing process (steam) at 90° C. for 20 min. Texture-free pollock surimi chunk as a control and commercial imitation crab meat of the same size were used.

For penetration test (gel strength), after a P/0.5S spherical probe was attached to a texture analyzer (TA.XT Plus, Texture Technologies, USA) and compressed to 50% at a speed of 1 mm/s, changes were recorded. For texture profile analysis (TPA), after a P/100 flat probe was attached to a texture analyzer (TA.XT Plus, Texture Technologies, USA) and compressed twice to 30% at a speed of 1.0 mm/s, changes in stress were recorded. The hardness, springiness, cohesiveness, resilience, and chewiness were determined. For cutting test (shear force), after a HDP/WBR blade probe was attached to a texture analyzer (TA.XT Plus, Texture Technologies, USA) and cut to 5 mm at a cutting speed of 1 mm/s in the direction parallel (A) or perpendicular (B) to the texture, changes were recorded.

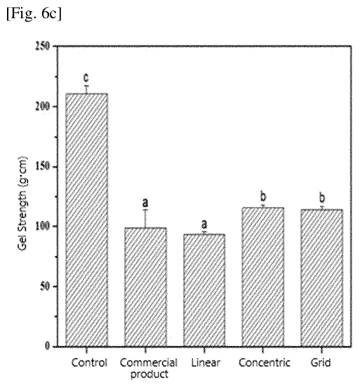

FIGS. 6a to 6c show the results of the penetration test on meat substitutes with various infill patterns for crustacean soft tissue. Specifically, FIGS. 6a to 6c show the breaking forces, penetration distances, and gel strengths of the meat substitutes. As shown in FIGS. 6a to 6c, gel strength is generally used to predict the physical properties of a sample and was calculated by the multiplication of breaking force and penetration distance. The texture-free control sample showed the highest gel strength, and the samples with concentric, grid, and linear patterns and the commercial imitation crab meat followed in this order. The reason for the highest gel strength of the control sample is because the control sample had an infill density close to 100%. That is, it is believed because the infill density of the control sample is higher than those of the other samples with infill patterns. In addition, since layers pile up against each other in the sample with a grid pattern, the grid pattern provides more anchor points within the structure compared to the linear pattern, allowing the food composition to form a more stable structure with the vertical shell and perimeter.

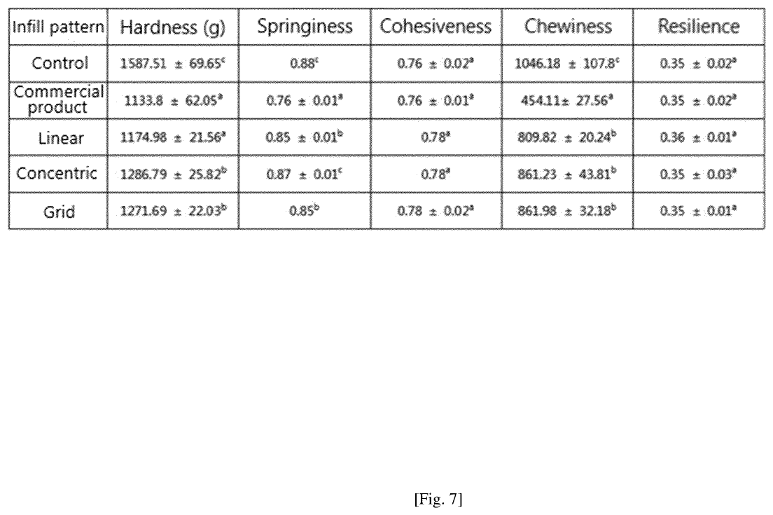

FIG. 7 is a table showing the results of the texture profile analysis (TPA) for the meat substitutes with different infill patterns.

The results in FIG. 7 confirm changes in the tested parameters depending on the infill pattern. The hardness showed a tendency similar to gel strength (commercial product, linear pattern<concentric and grid patterns<control). The springiness and chewiness values of the 3D printed samples were higher than those of the commercial product regardless of the infill pattern, demonstrating that the texture of real food can be successfully realized. The cohesiveness and resilience of all samples were not significantly different.

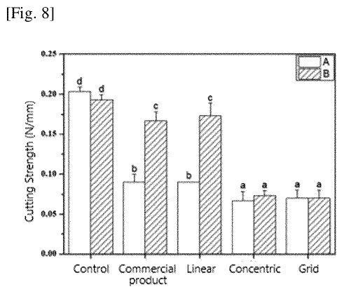

FIG. 8 shows the results of cutting tests for the meat substitutes with various infill patterns. As shown in FIG. 8, the shear force is generally similar to the sensation when food is first cut by the front incisors when the food enters the mouth and is generally used to evaluate food toughness. In addition, the shear force can be generally defined as an indicator for confirming fibrous structure and texture formation. There was no significant difference in shear force depending on the direction, except for the linear pattern. This is believed to be because the angle at which the probe and the sample with a linear structure meet varies depending on the direction in which the cutting force is applied. In other words, the cutting force applied parallel to the texture direction is less than the cutting force applied perpendicular to the texture direction. From the results shown in FIG. 8, it can be said that there were no significant differences between the 3D printed samples and the commercial product, demonstrating that the texture of real food can be successfully realized.

The results in FIGS. 6a to 8 concluded that the texture of food can be improved depending on the difference in internal structure and texture formation. In addition, it appears that this approach with 3D printing could provide consumers with on-demand nutrition and dining experience.

Although the present invention has been described herein with reference to the foregoing specific embodiments, these embodiments do not serve to limit the invention and are set forth for illustrative purposes. It will be apparent to those skilled in the art that modifications and improvements can be made without departing from the spirit and scope of the invention.

Simple modifications and changes of the present invention belong to the scope of the present invention and the specific scope of the present invention will be clearly defined by the appended claims.

### INDUSTRIAL APPLICABILITY

The method of the present invention uses a 3D printer equipped with a coaxial nozzle to produce a meat substitute for crustacean soft tissue in which distinct and tearable crustacean soft tissue can be realized. Therefore, the present invention is considered industrially applicable.

1. A method for producing a meat substitute for crustacean soft tissue, comprising (a) dissolving starch in water to form a starch gel and (b) feeding the starch gel into an outer nozzle of a dual-nozzle 3D printer in which an inner nozzle is insertedly arranged inside the outer nozzle, feeding a fish meat composition into the inner nozzle, and subjecting the starch gel and the fish meat composition to 3D printing into a predetermined shape while simultaneously ejecting the starch gel and the fish meat composition.

2. The method according to claim 1, wherein the concentration of the starch in the starch gel is 10 to 14%.

3. The method according to claim 1, wherein the starch is potato starch.

4. The method according to claim 1, wherein the fish meat composition comprises pollock surimi.

5. The method according to claim 1, wherein the outer nozzle has a diameter of 1.4 to 1.6 nm and the inner nozzle has a diameter of 0.8 to 1.2 nm.

6. The method according to claim 1, wherein, in step (b), the starch gel is ejected at a speed of 0.005 to 0.015 ml/min.

7. The method according to claim 1, wherein, in step (a), the starch dissolved in the water is gelatinized by stirring at 60 to 80° C.

8. The method according to claim 1, wherein, in step (b), the 3D printed material ejected through the dual nozzle comprises a core composed of the fish meat composition in the form of a yarn and a shell composed of the starch gel coated on the surface of the core.

9. The method according to claim 8, wherein, in step (b), the 3D printed material has at least one pattern selected from the group consisting of linear, grid, and circular patterns.
